(19) United States
(12) Patent Application Publication
(10) Pub. No.: US 2011/0155686 A1
(43) Pub. Date: Jun. 30, 2011

(54) PATTERNED CONTAINER HAVING INTEGRALLY MOLDED INDICIA

(76) Inventors: KIRK E. MAKI, Tecumseh, MI (US); George David Lisch, Jackson, MI (US)

(21) Appl. No.: 12/975,946

(22) Filed: Dec. 22, 2010

Related U.S. Application Data
(60) Provisional application No. 61/290,578, filed on Dec. 29, 2009.

(51) Int. Cl. B65D 1/02; B29C 45/16; B65D 90/00

(52) U.S. Cl. 215/40; 264/241; 425/130; 206/459.5

(57) ABSTRACT

A method and apparatus for forming a container including introducing an indicia material into an injection stream between an inner layer and an outer layer to form a preform. The method further includes shaping the preform into a container such that the container defines visual patterning along at least a portion thereof.

### CROSS-REFERENCE TO RELATED APPLICATIONS

This application claims the benefit of U.S. Provisional Application No. 61/290,578, filed on Dec. 29, 2009. The entire disclosure of the above application is incorporated herein by reference.

### FIELD

The present disclosure relates to plastic containers for retaining a commodity and, more particularly, a liquid commodity, whereby the plastic container comprises integrally molded indicia.

### BACKGROUND AND SUMMARY

This section provides background information related to the present disclosure which is not necessarily prior art. This section also provides a general summary of the disclosure, and is not a comprehensive disclosure of its full scope or all of its features.

As a result of environmental and other concerns, plastic containers, more specifically polyester and even more specifically polyethylene terephthalate (PET) containers, are now being used more than ever to package numerous commodities previously packaged in glass containers. Manufacturers and fillers, as well as consumers, have recognized that PET containers are lightweight, inexpensive, recyclable and manufacturable in large quantities.

PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\% Crystallinity = \frac{ρ - {ρ}_{α}}{{ρ}_{c} - {ρ}_{α}} \times 100$$

where ρ is the density of the PET material; ρ_{α} is the density of pure amorphous PET material (1.333 g/cc); and ρ_{c} is the density of pure crystalline material (1.455 g/cc).

Container manufacturers, in an attempt to market and identify their products to consumers, typically affix indicia to the container or form their container to be readily identifiable to consumers or otherwise elicit consumer interest. This can include unique container shapes and styles. These readily identifiable forms can also be useful for improving the operation of the container.

However, it should be appreciated that there are a number of disadvantages associated with conventional labels. By way of non-limiting example, conventional labels must obviously be manufactured separate from the container and, thus, add expense and complexity to the manufacturing process. The fact that conventional labels often contain elaborate artwork can lead to considerable expense and downtime when printing machines must be reconfigured for changes to such artworks. Furthermore, conventional labels are often made of material that is different than that of the container and, thus, must be separated from and processed differently during recycling. This added recycling complexity can lead to reduced recycling profitability and increased landfill waste.

More recently, there has been increased interest in vignette designs in or on containers. Accordingly, there has been development in the manufacture of containers having striping, patterning, or other designs or indicia through co-injection during the manufacturing process. According to the principles of the present teachings, a color test was conducted with a four cavity co-injection mold where bands of material were located at various positions within the container. It has been found that according to the principles of the present teachings, stripes, decoration, or other indicia extending vertically and/or horizontally in a container can be formed specifically in regions and/or in patterns previously unachievable. Much of these benefits can be achieved using novel nozzles according to the present teachings.

Therefore, an object of the present teachings is to provide a container that is able to overcome the disadvantages of manufacturing, cost, and complexity of conventional indicia systems. To achieve this, in some embodiments, a patterned container is provided that comprises a container body having a co-injected patterning, thereby eliminating the need for a separately manufactured label, decreasing manufacturing costs, and increasing flexibility in varying artwork and indicia.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a perspective view illustrating a patterned container according to the principles of the present teachings;

FIG. 1B is a photograph of the patterned container of FIG. 1A;

FIG. 2A is a perspective view illustrating a patterned container according to the principles of the present teachings;

FIG. 2B is a photograph of the patterned container of FIG. 2A;

FIGS. 3A-3D are a perspective views illustrating a patterned container according to the principles of the present teachings;

FIG. 4 is a cross-sectional view illustrating an injection device according to the principles of the present teachings;

FIG. 5A is a side view illustrating a nozzle according to the principles of the present teachings;

FIG. 5B is a cross-sectional view illustrating the nozzle according to FIG. 5A;

FIG. 5C is an end view illustrating the nozzle according to FIG. 5A showing an inner melt flow and an indicia melt flow;

FIG. 6 is a cross-sectional view illustrating a resultant preform from the nozzle according to FIG. 5

FIG. 7A is a side view illustrating a nozzle according to the principles of the present teachings;

FIG. 7B is a cross-sectional view illustrating the nozzle according to FIG. 7A;

FIG. 7C is an end view illustrating the nozzle according to FIG. 7A showing an inner melt flow and an indicia melt flow;

FIG. 8 is a cross-sectional view illustrating a resultant preform from the nozzle according to FIG. 7

FIGS. 9A-9F are end views illustrating nozzle tips according to the principles of the present teachings;

FIGS. 10A-10D are end views illustrating nozzle tips according to the principles of the present teachings;

FIG. 11A is a side view illustrating a sleeve according to the principles of the present teachings;

FIG. 11B is a cross-sectional view illustrating the sleeve according to FIG. 11A;

FIG. 11C is an end view illustrating the sleeve according to FIG. 11A;

FIG. 12A is a side view illustrating a sleeve according to the principles of the present teachings;

FIG. 12B is a cross-sectional view illustrating the sleeve according to FIG. 12A;

FIG. 12C is an end view illustrating the sleeve according to FIG. 12A;

FIG. 13A is a cross-sectional view illustrating a sleeve according to the principles of the present teachings;

FIG. 13B is a front view illustrating the sleeve according to FIG. 13A;

FIG. 13C is a side view illustrating the sleeve according to FIG. 13A;

FIG. 14A is a cross-sectional view illustrating a sleeve according to the principles of the present teachings;

FIG. 14B is a front view illustrating the sleeve according to FIG. 14A; and

FIG. 14C is a side view illustrating the sleeve according to FIG. 14A.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

In connection with the present teachings, a patterned container 10 is provided. It should be appreciated that patterned container 10 can have any shape and can be made of one of many different materials, such as plastic. It should, therefore, be understood that the following description of an exemplary container is only for purposes of discussion and should not be regarded as the only container configuration.

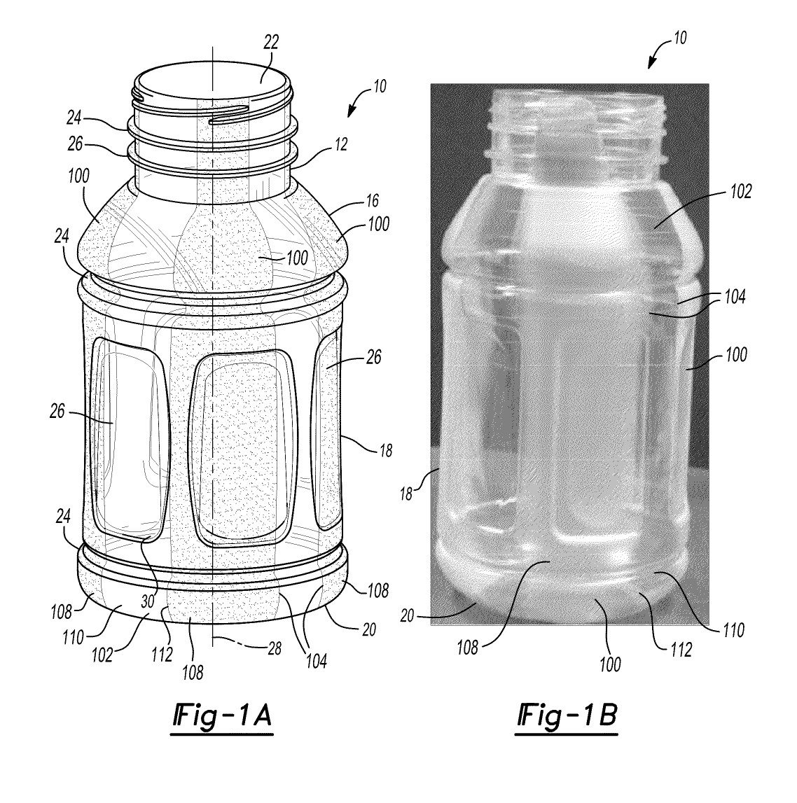

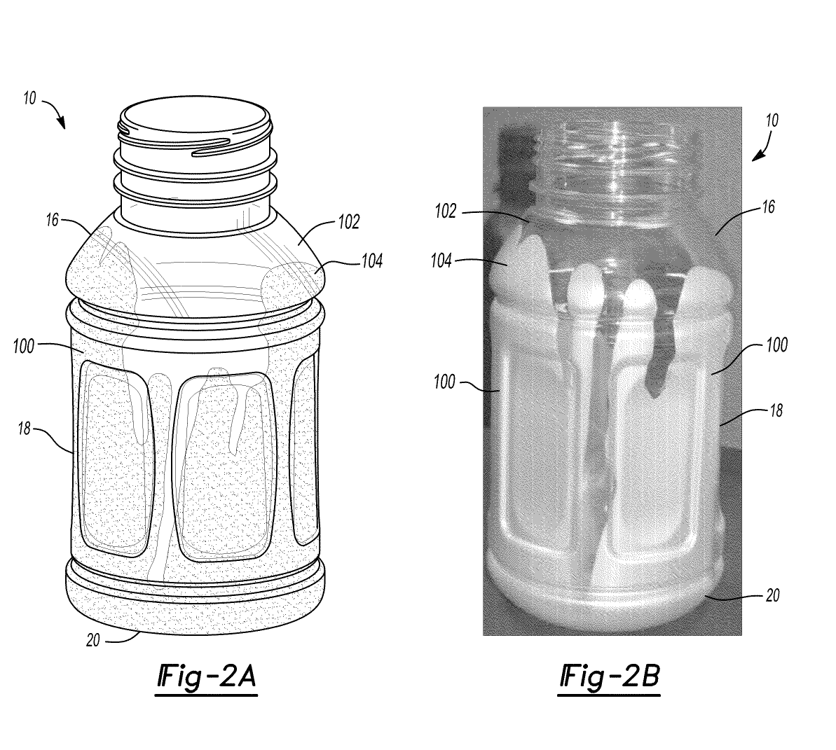

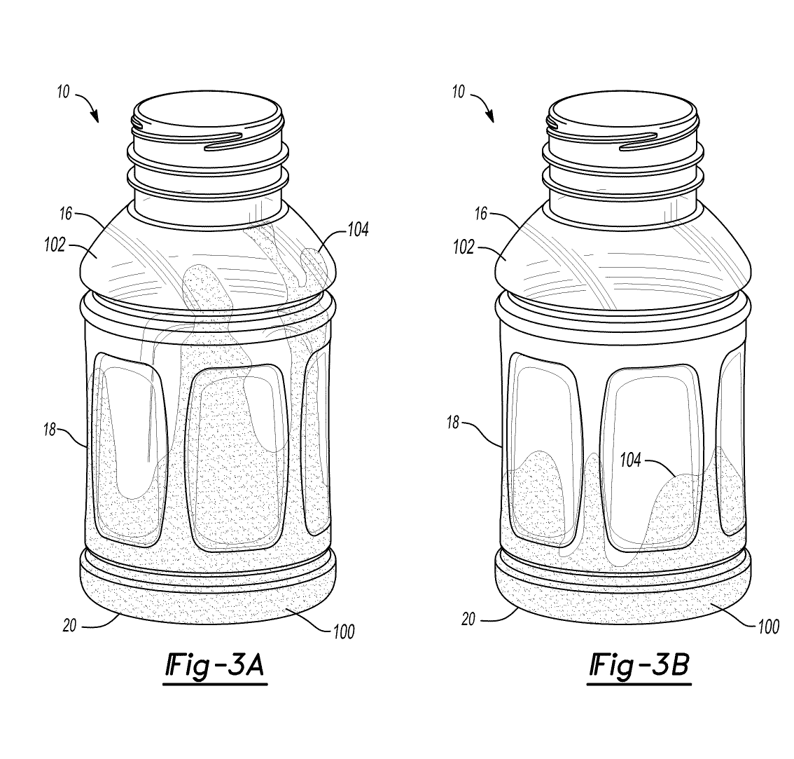

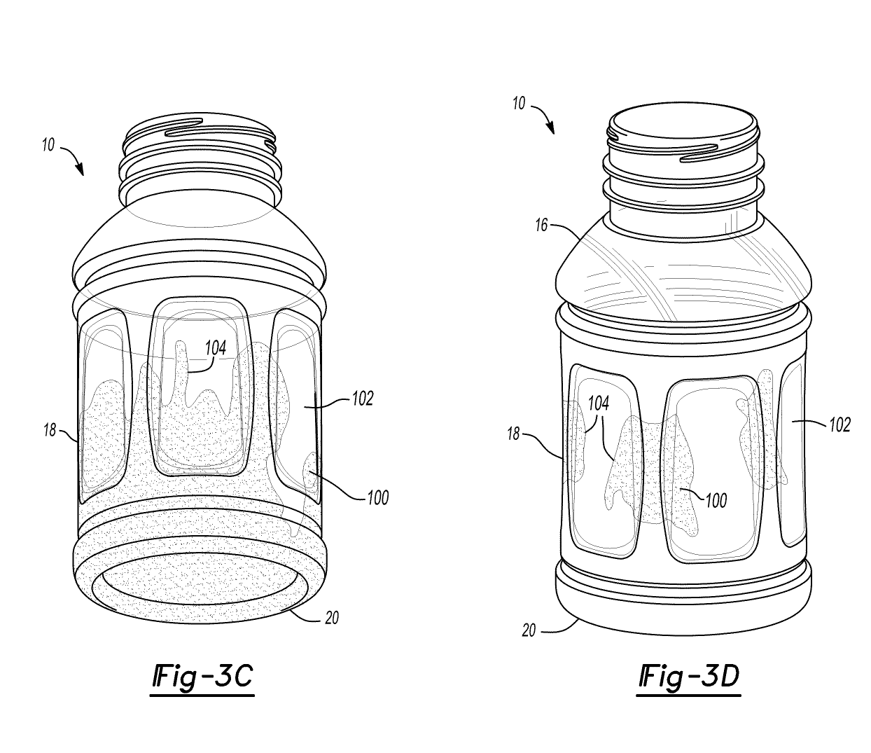

Generally, as illustrated in FIGS. 1A-3D, an exemplary patterned container 10 can comprise, in some embodiments, a plastic, e.g. polyethylene terephthalate (PET), container. Patterned container 10 can be sized to fit on the shelves of a supermarket or store. Patterned container 10 can be substantially circular in cross sectional shape. Patterned container 10 can comprise a finish 12, a shoulder region 16, a sidewall portion 18 and a base 20. Those skilled in the art know and understand that a neck (not illustrated) may also be included having an extremely short height, that is, becoming a short extension from the finish 12, or an elongated height, extending between the finish 12 and the shoulder region 16.

In some embodiments, finish 12 of patterned container 10 includes a portion defining an aperture or mouth 22, a threaded region 24, and a support ring 26. The aperture allows patterned container 10 to receive a commodity while the threaded region 24 provides a means for attachment of a similarly threaded closure or cap (not illustrated). Alternatives may include other suitable devices that engage the finish 12 of patterned container 10. Accordingly, the closure or cap (not illustrated) engages the finish 12 to preferably provide a hermetical seal of patterned container 10. The closure or cap (not illustrated) is preferably of a plastic or metal material conventional to the closure industry and suitable for subsequent thermal processing, including high temperature pasteurization and retort. The support ring may be used to carry or orient the preform (the precursor to patterned container 10) (not illustrated) through and at various stages of manufacture. For example, the preform may be carried by the support ring, the support ring may be used to aid in positioning the preform in the mold, or an end consumer may use the support ring to carry patterned container 10 once manufactured.

Integrally formed with the finish 12 and extending downward therefrom is the shoulder region 16. The shoulder region 16 merges into and provides a transition between the finish 12 and the sidewall portion 18. The sidewall portion 18 extends downward from the shoulder region 16 to the base 20.

Furthermore, patterned container 10 can further comprise one or more ribs 24 and vacuum panels 26 for improved management of internal vacuum forces and/or external loading forces and/or for improved aesthetics. It should be understood that the principles of the present teachings are equally applicable to uniform and non-uniform surfaces.

Patterned container 10 of the present teachings can be formed through co-injection molding into a container having a unitary construction, yet also having multiple layers for forming indicia 100. Indicia 100 can comprise any marking, pattern, or other design that is in contrast or different to a non-indicia area 102. As will be described, indicia 100 can define one or more different properties relative to non-indicia area 102, such a different color, contrast, opacity, material, or any other differing attribute. It should be appreciated that the term “material” may be used generically herein to describe a substance that permits one to achieve a one or more different attributes between indicia 100 and non-indicia area 102, such as different plastics, different additives, different recipes and so on. It should also be understood that the absence of an attribute or a different attribute (i.e. clear vs. colored, clear vs. opaque, red vs. blue, etc.) can be considered, in some embodiments, a non-indicia area 102.

Generally, as will be described in detail herein, the system of the present teachings employs a plurality of extruders, one for each color or material to be used (clear is considered a color), wherein such colors or materials pass through the plurality of extruders via a plurality of manifolds. The colors or materials enter a nozzle (described herein) in separate flows such that one flow is introduced in a controlled manner into another flow to form a preform. That is, each flow is separated from the larger main flow, and each flow can be adjusted individually to help balance or add variation.

A well-known stretch-molding, heat-setting two stage process for making patterned container 10 generally involves the manufacture of a preform (described herein) of a polyester material, such as polyethylene terephthalate (PET), having a shape well known to those skilled in the art similar to a test-tube with a generally cylindrical cross section and a length typically approximately fifty percent (50%) that of the resultant container height. In one example, a machine (not illustrated) places the preform heated to a temperature between approximately 190° F. to 250° F. (approximately 88° C. to 121° C.) into a mold cavity (not illustrated) having a shape similar to patterned container 10. The mold cavity is heated to a temperature between approximately 250° F. to 350° F. (approximately 121° C. to 177° C.). A stretch rod apparatus (not illustrated) stretches or extends the heated preform within the mold cavity to a length approximately that of the resultant container thereby molecularly orienting the polyester material in an axial direction generally corresponding with a central longitudinal axis 28 of patterned container 10. While the stretch rod extends the preform, air having a pressure between 200 PSI to 600 PSI (1.38 MPa to 4.14 MPa) assists in extending the preform in the axial direction and in expanding the preform in a circumferential or hoop direction thereby substantially conforming the polyester material to the shape of the mold cavity and further molecularly orienting the polyester material in a direction generally perpendicular to the axial direction, thus establishing the biaxial molecular orientation of the polyester material in most of the container. Typically, material within the finish 12 and a sub-portion of the base 20 are not substantially molecularly oriented. The pressurized air holds the mostly biaxial molecularly oriented polyester material against the mold cavity for a period of approximately two (2) to five (5) seconds before removal of the container from the mold cavity. This process is known as heat setting and results in a heat-resistant container suitable for filling with a product at high temperatures.

In another example, a machine (not illustrated) places the preform heated to a temperature between approximately 185° F. to 239° F. (approximately 85° C. to 115° C.) into the mold cavity. The mold cavity may be chilled to a temperature between approximately 32° F. to 75° F. (approximately 0° C. to 24° C.). Thereafter, a stretch rod apparatus (not illustrated), with the aid of pressurized air, stretches, extends and expands the preform as described above. This process is utilized to produce containers suitable for filling with product under ambient conditions or cold temperatures. In the alternative, a one stage process could also be utilized.

Alternatively, other manufacturing methods, such as for example, extrusion blow molding, one step injection stretch blow molding and injection blow molding, using other conventional materials including, for example, high density polyethylene, polypropylene, polyethylene naphthalate (PEN), a PET/PEN blend or copolymer, and various multilayer structures may be suitable for the manufacture of plastic patterned container 10. Those having ordinary skill in the art will readily know and understand plastic container manufacturing method alternatives.

The container patterning, that is the creation of various stripes, patterns, and other indicia in the side wall of the container, of the present teachings was tested using an exemplary single cavity tooling having hot runner components and various nozzle designs. It should be understood that the present teachings could be used in connection with a wide variety of applications, such as a clear strip down colored container; a multi-striped, spotted, and/or vignette container; and the like.

Various technical hurdles were overcome in connection with the present teachings, such as obtaining an area of color density that was sufficient to achieve a visually bold appearance. This was necessary in order to prove concept; however, it should be understood that the final material delineation in the container can vary depending on desired appearance. Moreover, in connection with the present teachings, and more significant in one stage applications than two stage applications, it was necessary to design a nozzle and method that minimized heat variations in the various flow materials that could adversely impact the final product formation. Temperature can also be used to drive up a loss in viscosity to create additional random effects. As such, generally stripes need to be somewhat close in temperature.

### Co-Injection Nozzle Design and Method of Use

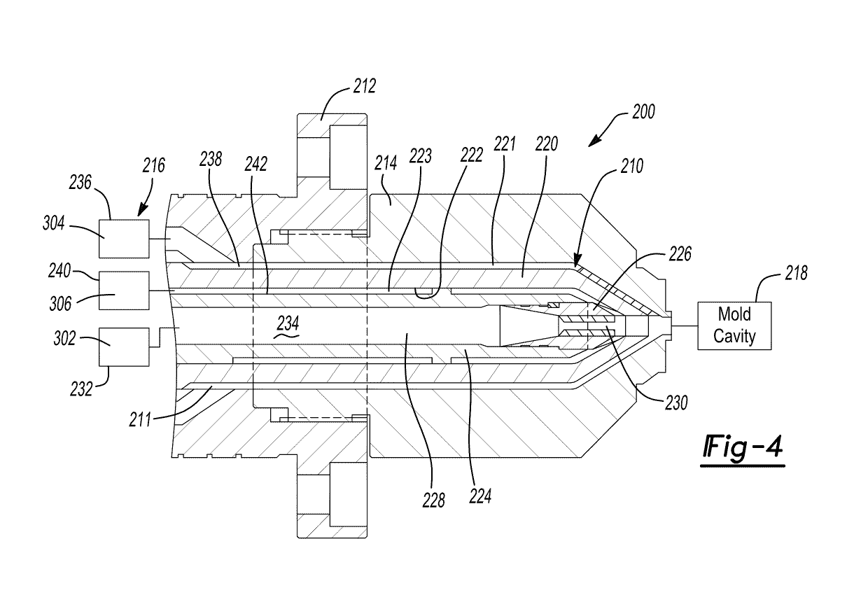

In some embodiments, the manufacturing process to achieve the benefits of the present teachings can be achieved as follows. As described herein and with particular reference to FIG. 4, an injection device 200 can be used to form the container 10 of the present teachings. The injection device 200 can comprise an injection system that introduces a plurality of materials through a nozzle assembly 210 according to the present teachings to form unique patterns and structures.

In some embodiments, injection device 200 can comprise nozzle assembly 210 captured within a volume 211 formed within a base housing 212 and an outer housing 214. Outer housing 214 is fixed coupled to base housing 212 via threads or other coupling system. Injection device 200 is operably disposed between a material supply system 216, supplying materials for injection, and a mold cavity 218, for receiving the injected materials.

In some embodiments, nozzle assembly 210 can comprise an outer sleeve 220 disposed within the volume 211 of base 212 and outer housing 214. An outer dimension of outer sleeve 220 is less than an inner dimension of volume 211 to define a first annulus 221. Nozzle assembly 210 can further comprise an inner sleeve 224 disposed within a hollow bore 222 of outer sleeve 220. An outer dimension of inner sleeve 224 is less than an inner dimension of hollow bore 222 of outer sleeve 220 to define a second annulus 223. Nozzle assembly 210 can still further comprise a nozzle 226 having a hollow bore 230. Nozzle 226 can be disposed with a hollow bore 228 of inner sleeve 224 such that hollow bore 228 of inner sleeve 224 is in fluid communication with hollow bore 230 of nozzle 226. Nozzle 226 can define an outer dimension that closely conforms to an inner dimension of hollow bore 228 to define a connection therebetween.

Therefore, nozzle assembly 210 defines a co-injection system wherein an inner layer material 302 from an inner layer material supply 232 can fluidly flow from inner layer material supply 232 to mold cavity 218 via an inner layer material passage 234 (via hollow bore 228 and hollow bore 230) as an inner melt flow.

Nozzle assembly 210 further defines a co-injection system wherein an outer layer material 304 from an outer layer material supply 236 can fluidly flow from outer layer material supply 236 to mold cavity 218 via an outer layer material passage 238 (via first annulus 221) as an outer melt flow.

Nozzle assembly 210 still further defines a co-injection system wherein an indicia material 306 from an indicia material supply 240 can fluidly flow from indicia material supply 240 to mold cavity 218 via an indicia layer material passage 242 (via second annulus 223) as an indicia melt flow.

Generally, during operation, inner layer material 302, outer layer material 304, and indicia material 306 will be injected in an overlapping, generally-concentric pattern within mold cavity 218 to define indicia 100 and non-indicia areas 102 in the final container 10. More particular, as seen in FIGS. 6 and 8, inner layer material 302 will be injected as a continuous, concentric inner melt flow layer forming an inner layer 410 within the resultant co-injection preform 400. Indicia material 306 will be injected as a non-continuous and/or intermittent indicia melt flow layer forming indicia layer 412 along an outer surface of inner layer 410 in areas to become indicia 100. Indicia material 306 will be absent from areas to become non-indicia areas 102. Finally, outer layer material 304 will be injected as a continuous, concentric outer melt flow layer forming an outer layer 414 of resultant co-injection preform 400.

It should be understood that, in some embodiments, the co-injection of inner layer material 302 and outer layer material 304 is continuous and uninterrupted throughout the injection process. However, the co-injection of indicia material 306 can occur continuously (such as to form vertical bands), intermittently (such as to form horizontal bands, swirls, islands, etc.), irregularly (such as to form variations in contrast, opacity, color, etc.), or in any other fashion relative to inner layer material 302 and/or outer layer material 304. It should also be understood that the flow rate, viscosity, material, temperature, and the like will all affect the final appearance and delineation of indicia 100 and non-indicia areas 102 in container 10.

### Nozzle Tip Design

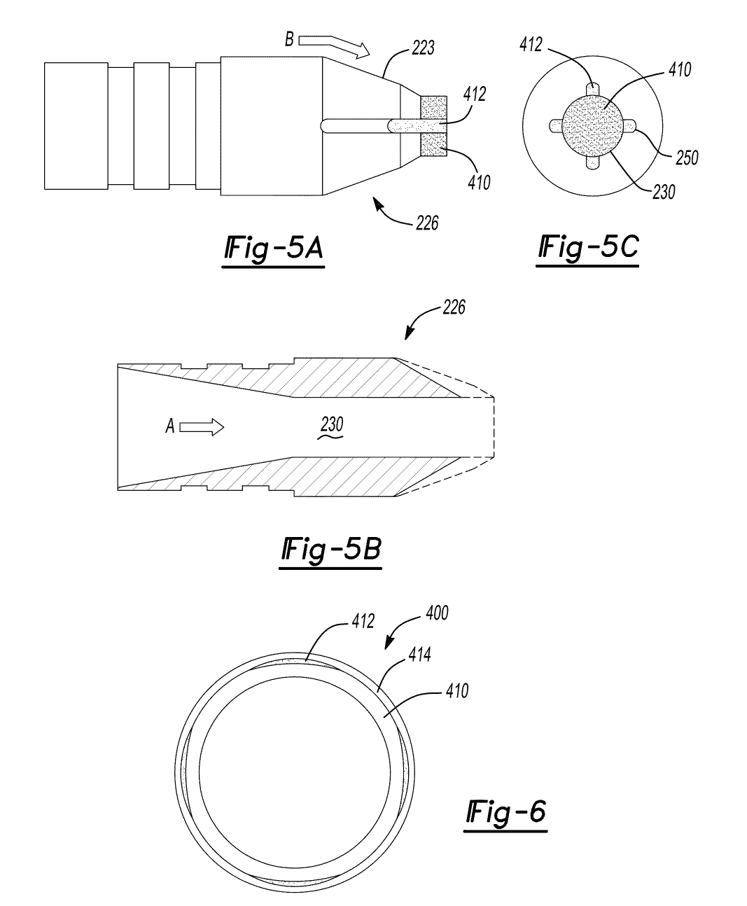

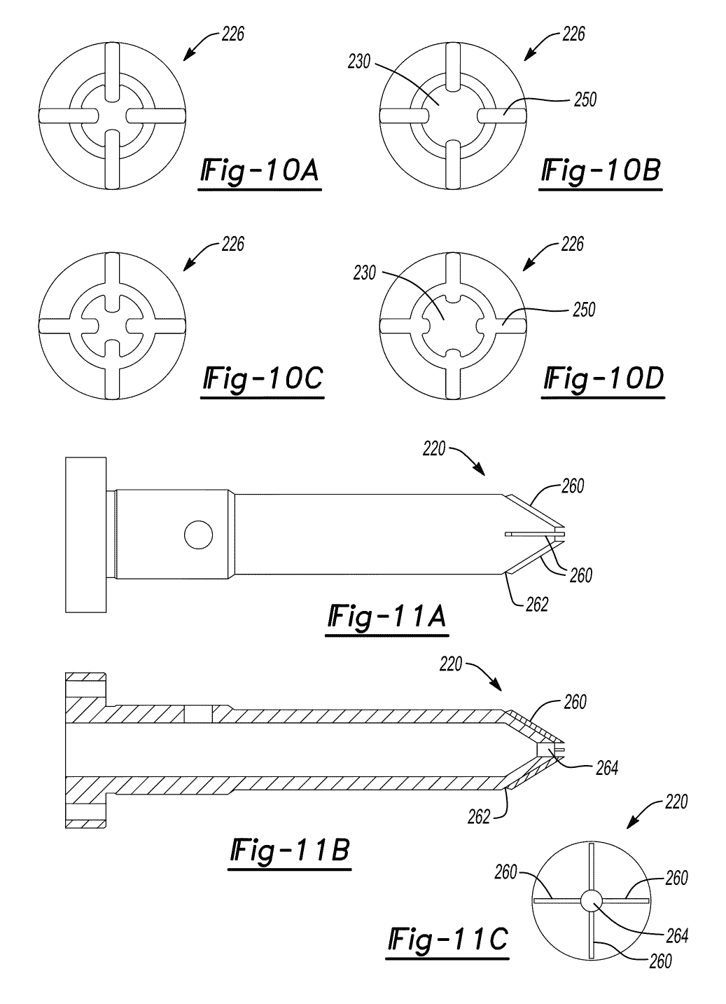

In some embodiments, nozzle design is critical to proper creation of the effect of the present teachings. In some embodiments, the nozzle 226 can be configured such that it seals off at least portions of the nozzle tip such that it separates the cylindrical indicia melt flow of indicia material 306 into distinct streams (see FIGS. 5A-5C, 7A-7C, 9A-9F, and 10A-10D). These discrete streams of indicia material 306 are designed to intersect and penetrate, in some embodiment, into the inner material melt flow and outer material melt flow.

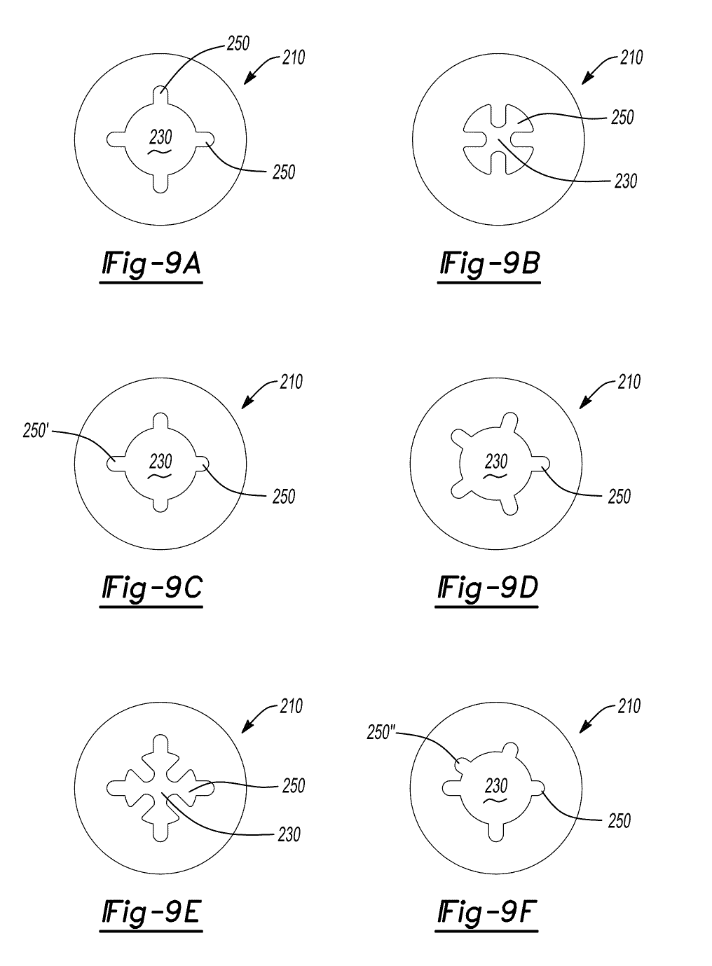

Still referring to the referenced figures, it should be appreciated that any one or a number of tip designs can be used to partition or otherwise interrupt the indicia melt flow and/or vary its presence in the resultant preform and container 10. For instance, nozzle 226 can comprise hollow bore 230, for inner melt flow, and discrete outlets 250 extending from second annulus 223, for indicia melt flow. Moreover, discrete outlets 250 can be arranged such that they are similarly sized and equally spaced (see FIG. 9A, 9B, 9D, 9E), differently sized relative to each other (see FIG. 9C, 9F), differently sized and unequally spaced (see FIG. 9F), and the like. These designs can create a flow interruption or dam on the flow edges, creating a low pressure area, or otherwise modify the flow of the materials.

The initial concept to break the flow into multiple streams has never been attempted before. The prevailing assumption was that the streams would develop too much turbulence or shear to make a good part. Either the stripes would create a part too hot to blow at the stripe, or the stripe would “break-up”. Staying close to the depth of the nozzle openings for the co-injection process, there was room to create openings of appropriate size to create a striping effect.

The injection of the flow did not get penetration of the inner and outer layers under the force of injection as anticipated. It appears to have created a laminar flow and spread between the layers with some penetration directly at the center but spreading out between the layers under the initial injection pressures and then as the volume is again reduced as it passes through the cavity gate opening.

It is anticipated that a more controlled stripe can be created by creating a relief in the pressure through the nozzle and, at the low pressure area, add the colorant. The inner and outer layer would both be interrupted in an attempt to create the narrowest stripe with deepest penetration into the inner and outer layer.

To this end and in reference to FIGS. 5A-5C, 7A-7C, and 11A-14D, nozzle assembly 210 can comprise any one of a number of feature used to contour the flow of one or more of inner melt flow, outer melt flow, and indicia melt flow. With particular reference to FIGS. 5A-5C, inner melt flow, generally referenced by Arrow A, can flow unimpeded through hollow bore 230 of nozzle 226. Indicia melt flow, generally referenced by Arrow B, can selectively flow and join an outer portion of inner melt flow. In this way, indicia melt flow B will contact inner melt flow A, but its penetration therein may be limited (see FIG. 6).

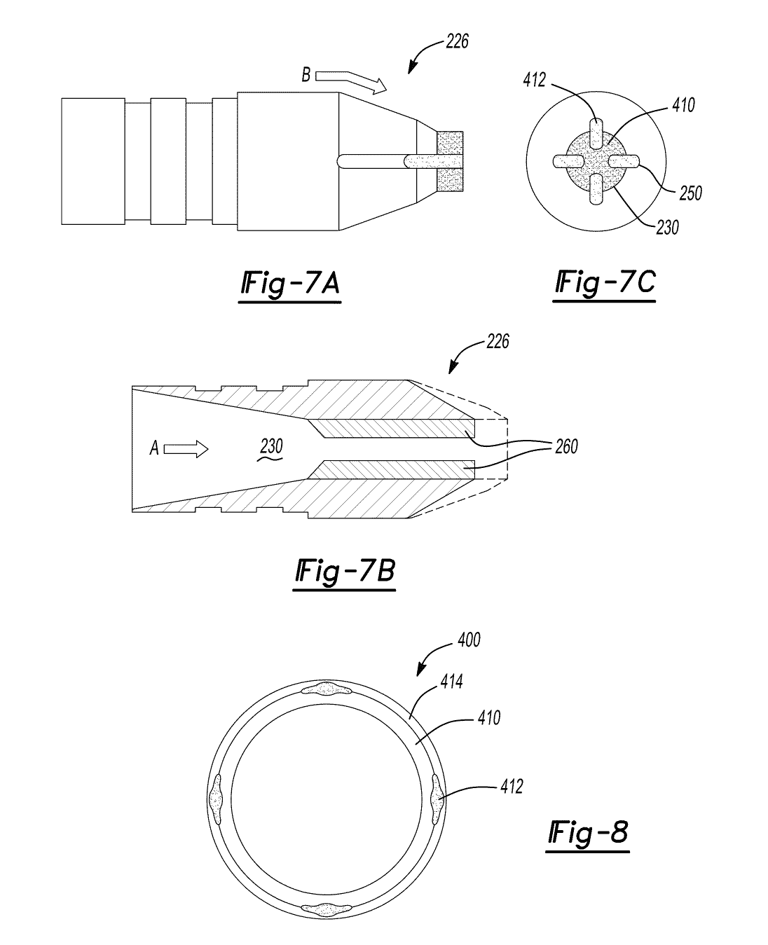

However, in some embodiments as illustrated in FIG. 7B, features or dams 260 can be disposed with hollow bore 230 of nozzle 226 to interrupt the inner melt flow A to create channels or low pressure areas within the inner melt flow A. Indicia melt flow B and the associated discrete outlets 250 can be positioned such that indicia melt flow B joins inner melt flow A, having low pressure areas, and is then drawn into and penetrates inner melt flow A with indicia melt flow B, resulting in deeper penetration of indicial melt flow B in inner melt flow A (see FIG. 8).

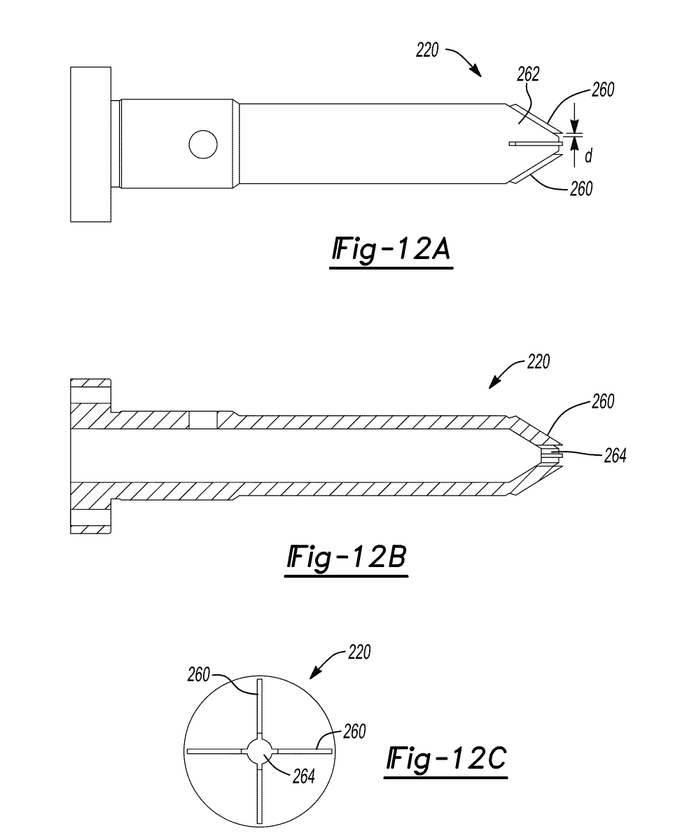

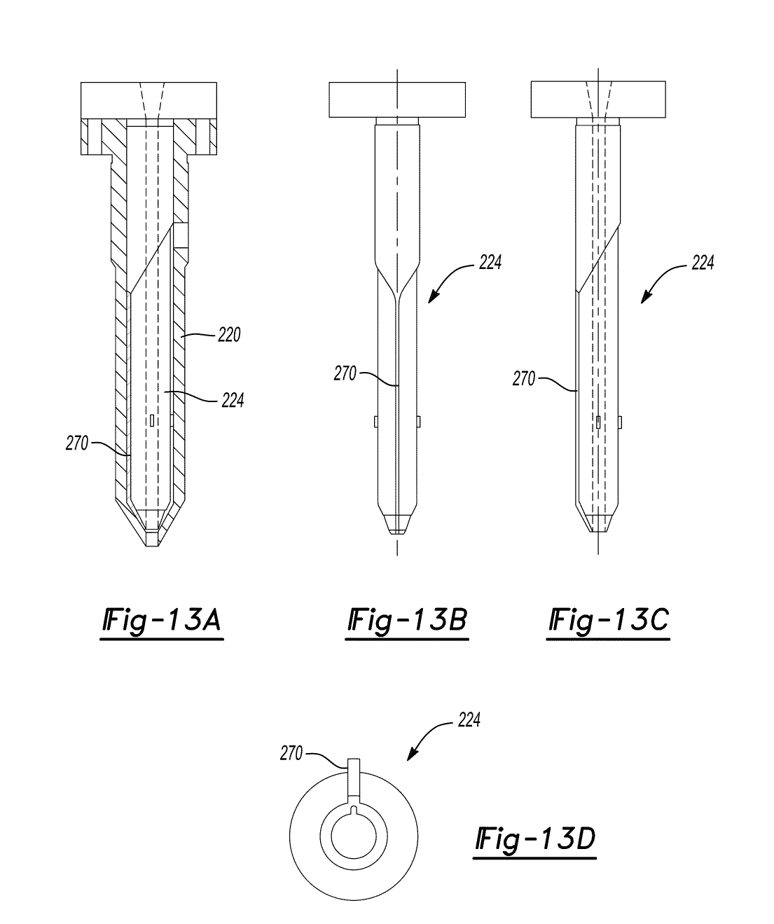

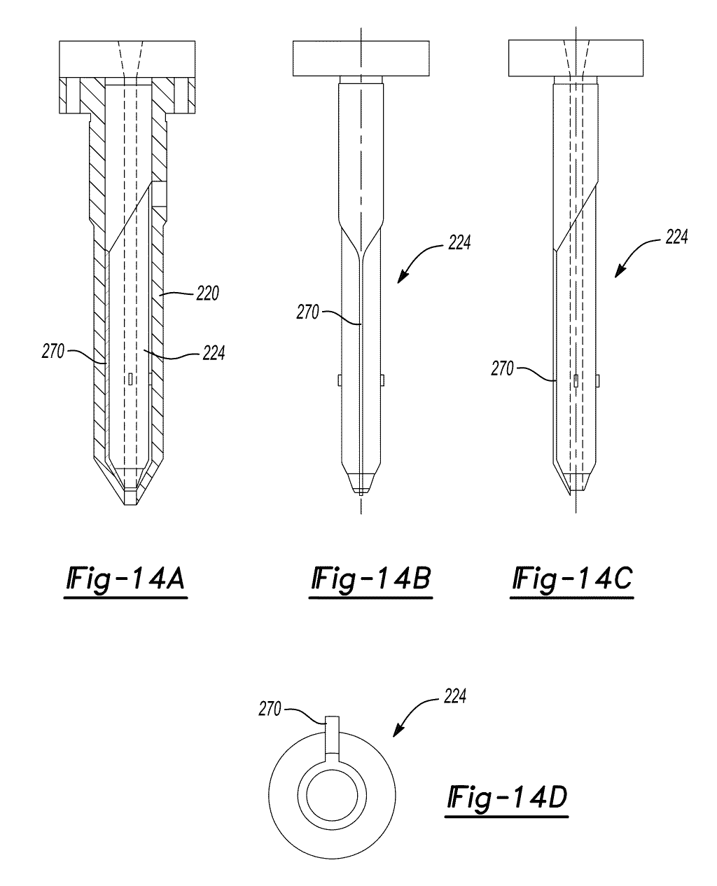

In some embodiments as illustrated in FIGS. 11A-14C, inner sleeve 220 can comprise one or more dams 260. In some embodiments, dams 260 can be disposed along an outer surface of distal tip 262 of sleeve 220. Dams 260 can be used to interrupt and/or separate portions of outer melt flow to contour or vary the resultant interface between indicia melt flow and inner melt flow with outer melt flow. With reference to FIGS. 11A-11C, dams 260 can extend to and bound an opening 264 extending through distal tip 262. In this way, the combination of inner melt flow and indicia melt flow exiting sleeve 220 will have a smooth and continuous outer surface and can be combined and joined with an interrupted outer melt flow. Alternatively, with reference to FIGS. 12A-12C, dams 260 can extend to a point spaced apart a distance d from opening 264 extending through distal tip 262 to form slots. In this way, the combination of inner melt flow and indicia melt flow exiting sleeve 224 will have slot-formed indicia melt flows extending from the inner melt flow that join with outer melt flow. Finally, in some embodiments as illustrated in FIGS. 13A-14D, a single rib 270 can be formed and extend along outer surface of sleeve 224 to form an interrupt in an otherwise continuous indicia melt flow. The extreme tip of single rib 270 can be extended to minimize turbulent flow, if desired (see FIGS. 14A-14C).

### Container Patterning

With particular reference to FIGS. 1A-3D, patterned container 10 can comprise any one of a plurality of unique pattern designs integrally molded into patterned container 10. As described herein, patterned container 10 can comprise indicia 100, non-indicia areas 102, and an interface 104 extending therebetween.

As described in the present application, the specific patterning of indicia 100 on patterned container 10 can be in nearly form, such as, but not limited to, vertically-oriented stripes or bands; horizontally-oriented stripes or bands; indicia disposed at and including one or more of finish 12, shoulder portion 16, sidewall portion 18, and base 20; swirls; drips; delineations; fingers; protrusions; random; and the like. Therefore, it should be recognized that the specifically illustrated containers of the present application should not be regarded as inclusive, as other variation are anticipated.

By way of non-limiting example and with reference to FIGS. 1A and 1B, patterned container 10 can comprise a plurality of vertically-oriented indicia bands 108 continuously extending from base 20 to finish 12 and being separated by non-indicia areas 110 similarly continuously extending from base 20 to finish 12, thereby resulting in a container having a plurality of vertical stripes. In some embodiments, indicia bands 108 can define an opacity different than non-indicia areas 110. However, it should be recognized that other variations can be used to differentiate indicia bands 108 and non-indicia areas 110, such as color or other material.

In some embodiments, interface 112, being the boundary between bands 108 and non-indicia areas 110 can be sharply defined (see FIG. 1A) or can be more gradually defined (see FIG. 1B). This can be achieved by varying the overall flow and material parameters, including temperature, pressure, flow rate, viscosity, materials, and the like.

Although the previous exemplary container was used to prove a generally uniform stripe could be made, the same general arrangement was used to achieve a dripping or flowing effect. This unique pattern on the container is from the material being allowed to enter between the layers at a much faster rate, overwhelming the ability of the material to stay in a straight stream and creating multiple and varied flow patterns. Rate, temperature, and viscosity differential can all create this effect, alone or in combination. The flowing pattern could be lengthened and shortened, and the containers had a “random” feel to them, but

### Logarithmic “Random” Shot of Multilayer Effects

In some embodiments, a “random” striping effect in the container can be created. It is anticipated that computer software can be used to modify the extruder shot size and injection velocity to enable the extruders to vary the shot parameters, within a given level, that would create a changing pattern with every shot.

### Random Striping Variations

As discussed above, striping can be randomized according to various methods. This can be achieved through the use of new tooling, processing, and/or materials. For example, striping can be randomized through the use of distinctive tooling that is operable to vary a melt stream as it enters the preform. Specifically, in embodiments where separate streams are introduced into the melt stream of the base material, tooling designs can be used that employ a different number and orientation of these melt streams in each cavity. This would create a varying effect in the final container configuration. Moreover, in some embodiments, the tooling can comprise a moving nozzle assembly that is operable to open and/or close the nozzle at independent timing intervals or on command to form various container patterns. Still further, nozzle designs can be manipulated to create uneven flow patterns, especially when injecting at velocities creating an overfill situation. The shape of these nozzle openings can be asymmetrical so that varying injection pressures and/or velocities will create different flow patterns along the container sidewall.

In terms of processing variations, the present teachings can further employ a machine configuration controlled by a PLC controller or the like. In this regard, it is possible to create software code that supplies an algorithm for randomly adjusting shot size and velocity to create a “random” appearance of stripes and/or patterning. The software code program can permits the current parameters to vary within a defined range of parameters to permit each container to appear unique from other containers. Specifically, the appearance can be controlled by variations in material volume.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A patterned container comprising:
a finish an opening formed therein;
a sidewall portion extending from said finish;
a base portion extending from said sidewall portion and enclosing said sidewall portion to form a volume therein for retaining a commodity;
a non-indicia area molded into at least one of said finish, sidewall portion, and base portion, said non-indicia area having an inner layer and an outer layer; and
an indicia area integrally molded into at least one of said finish, sidewall portion, and base portion, said indicia area having said inner layer, said outer layer, and an indicia layer disposed between said inner layer and said outer layer.

2. The patterned container according to claim 1 wherein said indicia area is visibly different from said non-indicia area.

3. The patterned container according to claim 1 wherein said indicia area defines a first color, said non-indicia area defines a second color, said first color being different than said second color.

4. The patterned container according to claim 1 wherein said indicia area defines a first opacity, said non-indicia area defines a second opacity, said first opacity being different than said second opacity.

5. The patterned container according to claim 1 wherein said inner layer is made of a first material, said outer layer is made of a second material, and said indicia layer is made of a third material, said third material being different than at least one of said first material and said second material.

6. The patterned container according to claim 1 wherein said inner layer is made of a first material, said outer layer is made of a second material, and said indicia layer is made of a third material, said first material, second material, and third material are each different than the other.

7. The patterned container according to claim 1 wherein said indicia area is integrally molded in said sidewall portion only.

8. The patterned container according to claim 1 wherein said inner layer and said outer layer are concentrically disposed.

9. The patterned container according to claim 1 wherein said inner layer, said outer layer, and said indicia layer are each concentrically disposed.

10. A container comprising:
a finish having a container opening;
a shoulder portion extending downward from said finish; and
a sidewall portion interconnecting said shoulder portion to a base portion,
wherein at least one of said shoulder portion, said sidewall portion and said base portion includes a plurality of differing materials concentrically layered capable of defining an indicia area and a non-indicia area.

11. The container according to claim 10 wherein said plurality of differing materials concentrically layered comprises an inner layer extending along an inner surface of said at least one portion, an outer layer extending along an outer surface of said at least one portion, and an intermittent layer disposed between said inner layer and said outer layer to form said indicia area.

12. The container according to claim 11 wherein said inner layer is made of a first material, said outer layer is made of a second material, and said indicia layer is made of a third material, said third material being different than at least one of said first material and said second material.

13. The container according to claim 11 wherein said inner layer is made of a first material, said outer layer is made of a second material, and said indicia layer is made of a third material, said first material, second material, and third material are each different than the other.

14. The container according to claim 10 wherein said indicia area is visibly different from said non-indicia area.

15. The container according to claim 10 wherein said indicia area defines a first color, said non-indicia area defines a second color, said first color being different than said second color.

16. The container according to claim 10 wherein said indicia area defines a first opacity, said non-indicia area defines a second opacity, said first opacity being different than said second opacity.

17. The container according to claim 10 wherein said indicia area is integrally molded in said sidewall portion only.

18. A method of forming a container, said method comprising:
injecting a first material as an inner melt stream;
injecting a second material as an outer melt stream concentrically disposed about said inner melt stream;
selectively injecting a third material as an indicia melt stream between said inner melt stream and said outer melt stream, said indicia melt stream at least partially interrupting a combination of said inner melt stream and said outer melt stream to form a preform; and
shaping said preform into a container, said container having an indicia area and a non-indicia area.

19. The method according to claim 18, further comprising:
interrupting at least a portion of said indicia melt stream to vary at least one of said indicia area and said non-indicia area.

20. The method according to claim 18 wherein said selectively injecting said third material as said indicia melt stream between said inner melt stream and said outer melt stream comprises selectively injecting said third material as said indicia melt stream such that said indicia melt stream penetrates into at least one of said inner melt stream and said outer melt stream.

21. The method according to claim 18 wherein said selectively injecting said third material as said indicia melt stream between said inner melt stream and said outer melt stream comprises selectively injecting said third material concentrically about at least a portion of said inner melt stream.

22. The method according to claim 18 wherein said selectively injecting said third material as said indicia melt stream between said inner melt stream and said outer melt stream comprises selectively injecting said third material using a contoured nozzle tip to shape said indicia melt stream into a plurality of melt streams.

23. The method according to claim 22 wherein shaping said indicia melt stream into a plurality of melt streams comprises shaping said indicia melt stream into a plurality of identical melt streams.

24. The method according to claim 22 wherein shaping said indicia melt stream into a plurality of melt streams comprises shaping said indicia melt stream into a plurality of melt streams equidistantly disposed about said inner melt stream.

25. The method according to claim 22 wherein shaping said indicia melt stream into a plurality of melt streams comprises shaping said indicia melt stream into a plurality of melt streams irregularly disposed about said inner melt stream.

26. The method according to claim 22 wherein shaping said indicia melt stream into a plurality of melt streams comprises shaping said indicia melt stream into a plurality of melt streams having different sizes.

27. An injection device for forming a preform, said injection device comprising:
a first material source having a first material;
a second material source having a second material;
a third material source having a third material;
a nozzle member being fluidly coupled to said first material source, said second material source, and said third material source, said nozzle member receiving said first material, said second material, and said third material and concentrically layering said first material and said third material to form non-indicia areas in a resultant preform and concentrically layering said first material, said second material, and said third material to form indicia areas in the resultant preform.
